(19) United States
(12) Patent Application Publication
(10) Pub. No.: US 2007/0005696 A1
(43) Pub. Date: Jan. 4, 2007

(54) Method for host transfer in a virtual collaboration session

(76) Inventors: Theodore W. Beers, Corvallis, OR (US); April Slayden, Redwood City, CA (US); Jim Borg, Lebanon, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/174,024

(22) Filed: Jul. 1, 2005

(51) Int. Cl. G06F 15/16

(52) U.S. Cl. 709/204

(57) ABSTRACT

A method of switching from a first host to a second host during a virtual collaboration session includes the first end node receiving a host transfer signal. In response, the first end node freezes the desktop transmitted to the end nodes of the virtual collaboration session followed by the second end node arranging the elements of the desktop to coincide with the elements of the frozen desktop. The method concludes with the second end node unfreezing the desktop and transmitting the desktop to the end nodes of the virtual collaboration session.

### BACKGROUND OF THE INVENTION

In a virtual collaboration session, in which participants work “together” in real-time in a virtual space while being physically located perhaps thousands of miles apart from each other, there are occasions where the management and control of the virtual collaboration resources becomes a distraction to the participants. This can reduce the efficiency of some or all of the participants as they struggle to understand and make use of an unfamiliar telecommunications and multimedia system that enables the virtual collaboration. Thus, when the participants meet to collaborate in order to understand and solve particular business, scientific, or technical problems, they must first understand and learn to operate the virtual collaboration resources, such as the monitors, cameras, microphones, and other equipment. This diminishes the appeal of using virtual collaboration resources and can cause the participants to lose their enthusiasm for solving the particular business, scientific, or technical problems that are the subject of the virtual collaboration session.

In other instances, some participants in a virtual collaboration session can be made to feel as though they are not fully engaged with the other participants of the session. Some users may feel as though they are looking through a window watching others solve problems while they themselves remain uninvolved. This can become especially apparent when one participant is in control of a particular resource, such as a camera focused on him or her for an extended period of time. In this event, the other participants may feel as though they are on the receiving end of a monologue being given by a presenter while having little opportunity to actively participate in the collaboration activities. In these instances, ease of transition from one presenter to another can enable all of the participants to feel more engaged and more involved in the virtual collaboration session. This can make these collaboration sessions more efficient and less fatiguing as all of the participants become more included in the collaboration session.

### BRIEF DESCRIPTION OF THE DRAWINGS

FIG. 1 is a block diagram of a host end node broadcasting to receiving end nodes in a virtual collaboration session according to an embodiment of the invention.

FIG. 2 is a chart showing a process of host transfer from a first end node to a second end node in a virtual collaboration session according to an embodiment of the invention.

FIG. 3 is a flowchart for a method of host transfer in a virtual collaboration session according to an embodiment of the invention.

FIG. 4 is a second flowchart for a method of host transfer in a virtual collaboration session according to an embodiment of the invention.

### DESCRIPTION OF THE EMBODIMENTS

In one embodiment, a method for host transfer in a virtual collaboration session enables the participants of the session to seamlessly take control of various system resources that constitute the virtual collaboration environment. These resources may include cameras focused on various individuals located at remote sites, document cameras focused on printed material being discussed during the session, facsimile machines that transmit and receive paper documents, and so forth. These resources are published so that all of the participants of the session can have equal access to the resources during the session without one participant needing to “grant” access to the resource. Rather, all participants have access to all resources at any given time. This allows each user to more actively participate in the virtual collaboration session. As an example, a participant at a first location may easily select a camera focused on a document at a second location so that the particular document can be discussed during the collaboration session.

It is also contemplated that before, during, and after the host transfer from a first end node to a second end node, the desktop viewed by each of the participants of the virtual collaboration session remains substantially or completely unchanged. Thus, as the host function is transferred from the first end node to the second end node, participants located at other receiving nodes during the session see a desktop image that appears continuous throughout the host transfer process. This can ensure that participants are not distracted by the second end node's desktop awkwardly supplanting the first host's desktop when a host transfer occurs.

In the context of the present invention, a broad definition of a “desktop” is contemplated. As the term is used herein, a desktop may refer to the metaphor used to portray file systems consisting of icons showing files, folders, various types of documents, and so forth. A desktop is contemplated as being a functional element of a system, rather than referring to specific hardware elements. Thus, a desktop may be displayed on a laptop or tablet computer, hand-held computing device, or other display device such as a projector, high-definition monitor, or other device that that temporarily presents information to participants in a visual form during the virtual collaboration session.

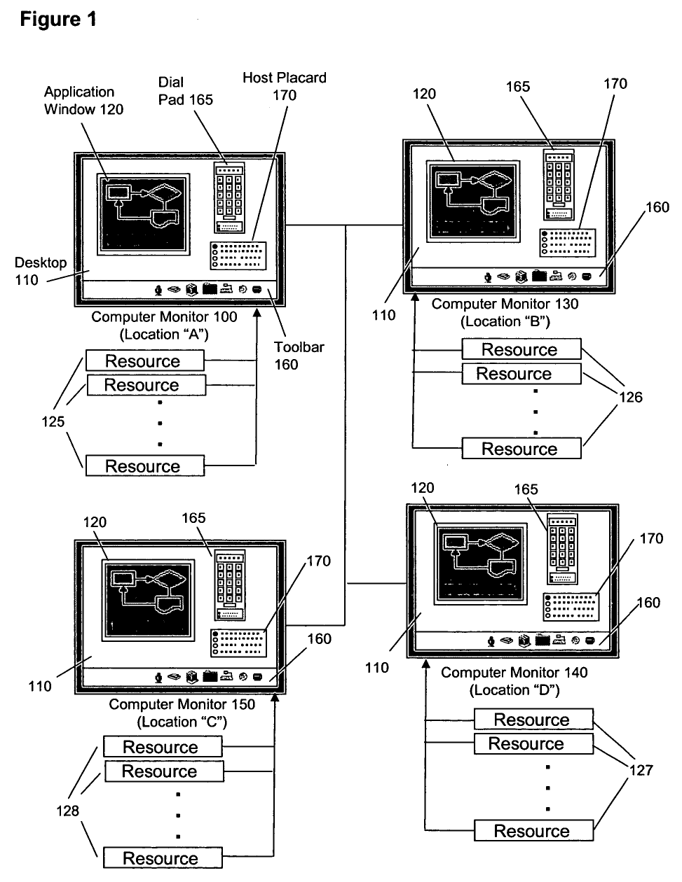

FIG. 1 is a symbolic representation of a host end node transmitting to various receiving end nodes in a virtual collaboration session according to an embodiment of the invention. In FIG. 1, computer monitor 100 located in city A, displays desktop 110 and application window 120. Computer monitor 130, located in city B, also displays desktop 110 and application window 120. Computer monitors 140 and 150, which represent a group of end nodes located in cities C and D (respectively), also display desktop 110 and application window 120. Coupled to each of computer monitors 100, 130, 140, and 150 are resources 125, 126, 127, and 128, respectively, by way of an intervening computing device (not shown). Thus, in the example of FIG. 1, at least 12 resources are available to the meeting participants.

To access a resource during a virtual collaboration session, the participant selects the appropriate icon displayed on tool bar 160, which indicates the resources available to all of the participants of the virtual collaboration session. In the example of FIG. 1 (from left to right) the resources available to all of the participants include a microphone, a scanner, a processing or storage resource, a folder containing electronic files, a document camera, a compact disc or DVD drive, and a printer. Thus, all of the participants of the virtual collaboration session have access to all of the resources available to end node A and directly control those resources by way of interacting with end node A's desktop. However, in the more general sense, nothing prevents any participant located at any end node from accessing a resource coupled to another end node by way of a host transfer to the appropriate end node.

In the context of FIG. 1, computer monitors 100, 130, 140, and 150 display application window 120, within which data from particular resource is viewed. In FIG. 1, application window 120 displays image of a document being captured by a document camera associated with a host end node in the virtual collaboration session. However, at other times during the collaboration session, application window 120 may display information from any other resource, such as images of participants present at a host end node, spread sheets, word processing files, graphics files, or any other image or file that can be presented using conventional software applications.

The area outside of application window 120 is referred to herein as the desktop. In FIG. 1, the desktop includes host placard 170, which displays information as to the current host end node of the collaboration session. Thus, the top radio button within host placard 170 may represent an end node in the city New York (A), the second radio button may represent an end node in another city such as Chicago (B), the third radio button may represent an end node in San Francisco (C), and the fourth radio button may represent an end node in Singapore (D).

In FIG. 1, it is contemplated that the end nodes located in cities A, B, C, and D each run an instance of a particular virtual collaboration software application within application window 120. Thus, commands which are transmitted among end nodes A, B, C, and D may be high-level descriptors that perhaps convey metadata or object names used in an object-oriented software application. In the example of FIG. 1, end node A (having desktop 110) broadcasts to a group of receiving end nodes B, C, and D. Further, the document image displayed in window 120 is contemplated as being present at end node A and being viewed by way of a document camera or other image capture resource connected to end node A.

In one example, when a participant located at another end node, for example end node B, wishes to view a document or make use of any other of resources 125 associated with end node A, end node A assumes the role of the host. As the host, end node A broadcasts desktop 110 to end nodes B, C, and D, such as is illustrated in FIG. 1. End node A remains as the host so long as the resource coupled to end node A is displayed within application window 120. When the participant located at end node B wishes to make use of a resource located at an end node other than A, such as end node D, end node A initiates a host transfer to end node D (as an example).

Thus, embodiments of the present invention provide for a seamless transfer from a first host to a second host, as participants of the collaboration session choose which resources are to be used during the session. As will be explained in greater detail herein, a method of switching from a first to a second host during a virtual collaboration session includes a second end node receiving a request to use a resource coupled to the second end node. The first end node (currently the host) freezes the desktop presented to all end nodes participating in the collaboration session, which, for the example of FIG. 1, includes end nodes B, C, and D.

While the frozen image of the desktop is being presented to the end nodes, the first end node directs the second end node to assume the role of the host. The first end node then transmits each of the elements of the desktop to the second end node using high-level commands. The second end node, in turn, arranges the elements of the desktop to coincide with the frozen image transmitted by the first end node. When this arrangement is complete, the second end node unfreezes the display, and begins transmitting updated images of the desktop to all other end nodes. Thus, other participants in the virtual collaboration session may notice only a very brief period of a frozen desktop, while the session host is transferred from the first to the second end node. The only noticeable change is the content of application window 120, within which another document, spread sheet, word processing file, graphics file, or any other file is displayed as desired by the participant at the second end node. Host placard 170 also shows the current host as changing from the first to the second end node.

When the resource selected by participant brings about a change in audio being transmitted to the end nodes, one embodiment of the invention may also include blanking or suppressing an audio signal from a first end node during the host transfer from the first end node to a second end node. By blanking or suppressing the audio being conveyed to the receiving end nodes during the host transfer, any distracting audio transients introduced during audio switching can be minimized or eliminated entirely.

Although only four end nodes are shown in FIG. 1, other embodiments of the invention may include a lesser number of end nodes, such as two or three, or may include a greater number of end nodes, such as 10 or more. Further, toolbar 160 may include a lesser or a greater number of icons than those shown in FIG. 1. Additionally, selecting a particular icon on toolbar 160 may also bring about the display of a list of resources of a similar type. As an example, a participant may select the icon for a document camera and be presented with a list of document camera resources coupled to the various nodes of the collaboration session. The displayed list may also include a default selection in which the document camera associated with the current host end node is selected. When the user selects a document camera associated with an end node other than the current host end node, a host transfer to the appropriate end node is initiated.

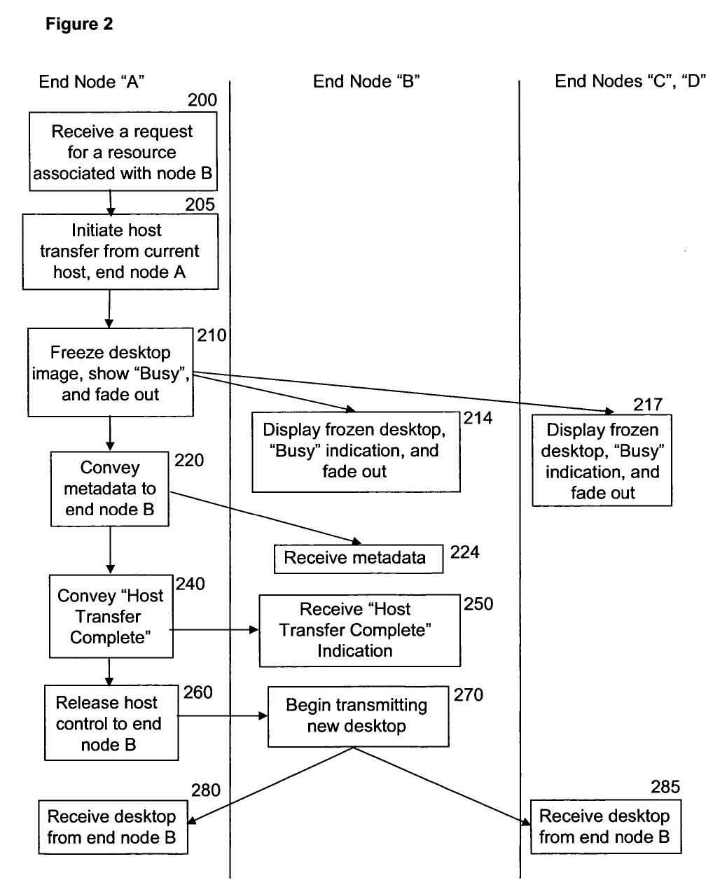

FIG. 2 is a chart showing a process of host transfer in a virtual collaboration session according to an embodiment of the invention. FIG. 1 represents a system that is suitable for performing the method of FIG. 2, although the method may be performed by other systems and equipment arrangements. For the example of FIG. 2, it has been assumed that end node A is currently acting as the host and is transmitting a copy of its desktop to end nodes B, C, and D. FIG. 2 begins at step 200, in which end node A receives a request for a resource associated with end node B. This request may originate from a participant located at another end node, or may originate from a participant located at end node B. In either case, in response to the request for the resource, step 205 is performed in which end node A initiates a host transfer from end node A to end node B.

At step 210, end node A freezes the desktop that is being transmitted to end nodes B, C, and D. In some embodiments of the invention, such as that of FIG. 2, step 210 may additionally include end node A transmitting a “busy” indication to end nodes B, C, and D as well as end node A fading-out the image of the frozen desktop. This may be useful especially in circumstances where bandwidth constraints, latency, or other factors dictate that a frozen desktop be transmitted to end nodes B, C, and D for an extended period of time, such as five seconds or longer. In these instances, posting a “busy” indication may be useful to alert the participants that the display has not “locked-up”, but is only being frozen during the host transfer. When the host transfer has been completed, end node B may slowly fade-in the desktop. This fade-out and fade-in may provide a sense of visual comfort to the participants as host transitions are made in a graceful manner. In the event that a busy indication is transmitted from end node A as well as the display fading-out, steps 214 and 217 are performed, in which end nodes B, C, and D display the desktop as the busy indication is posted and the desktop fades-out.

However, although fading-out and posting a “busy” indication may be useful under some circumstances, the inventors contemplate that under most circumstances, the communication channels that couple the various end nodes to each other are of such quality that the host transfer occurs almost immediately, such that there is no need for the desktop to fade-out or to post a “busy” indication. Further, the actual length of time during which the frozen desktop is presented to the participants is also contemplated as being insignificant.

Returning to the method of FIG. 2, at step 220, metadata describing the desktop is transmitted from end node A and received at end node B (in step 224). The metadata may include the location of the toolbar 160 (of FIG. 1), the icons present in the toolbar, the location and size of application window 120, the contents and location of host placard 170 and of dial pad 165, and so forth. At step 240, end node A conveys an indication to end node B that informs end node B that all of the elements of the desktop have been transmitted. At step 250, end node B receives the indication. At step 260, end node A releases host control to end node B. At step 270, end node B begins transmitting the desktop to end nodes A, C, and D. This may include fading-in the desktop as the desktop becomes active and removing the “busy” indication. In step 270, end node B transmits the new desktop, beginning with the final frame presented by end node A. At steps 280 and 285, end nodes A, C, and D receive the desktop image transmitted by end node B.

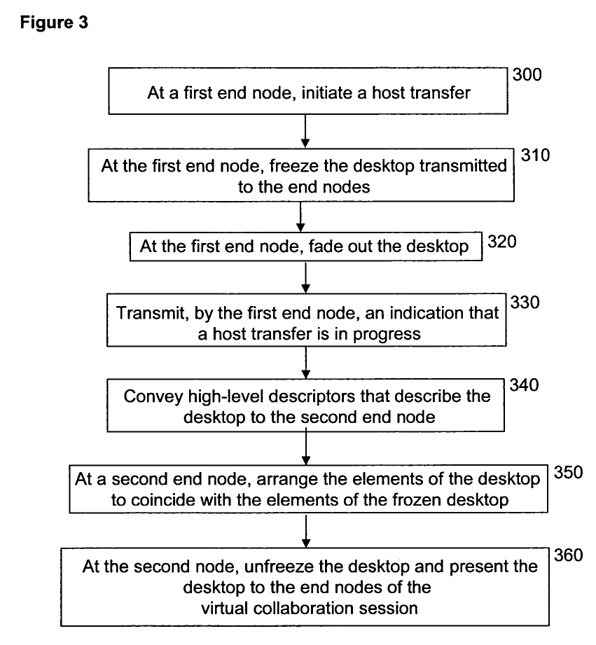

FIG. 3 is a flowchart for a method of switching from a first host to a second host during a virtual collaboration session according to an embodiment of the invention. FIG. 1 represents a system that is suitable for performing the method of FIG. 3, although the method may be performed by other systems and equipment arrangements. Prior to the beginning of the method of FIG. 3, it is assumed that the first end node is functioning as the session host and is thus transmitting an image of its desktop to the other end nodes of the collaboration session.

The method begins at step 300, in which the first end node initiates a host transfer signal from a second end node. In the embodiment of FIG. 3, the first end node initiates the host transfer to the second end node in response to a participant requesting access to a resource coupled to the second end node (such as a document camera). At step 310, the first end node freezes the desktop that is presented to the receiving end nodes. In step 320, the first end node fades-out the desktop that is presented to the receiving end nodes.

The method continues at step 330, which includes transmitting (to all of the end nodes of the collaboration session) an indication that a host transfer is in progress. Step 340 is then performed, which includes conveying high-level descriptors (such as metadata or object names) that describe the desktop to the second end node. In the embodiment of FIG. 3, all end nodes of the collaboration session run an instance of the user interface program being run at the first end node. Thus, it is contemplated that desktop “state” information can be shared among the various nodes of the session using high level descriptors. Step 350 is then performed in which the second node arranges the elements of the desktop to correspond with the elements of the frozen desktop. At step 360, the second node unfreezes the desktop and presents the desktop to the end nodes of the virtual collaboration session.

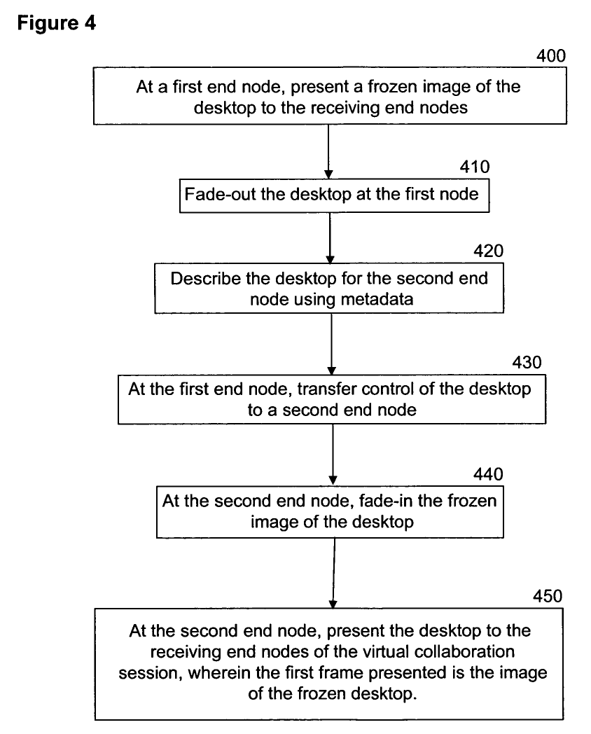

FIG. 4 is a second flowchart for a method of switching hosts during a virtual collaboration session. FIG. 1 represents a system that is suitable for performing the method of FIG. 4, although the method may be performed by other systems and equipment arrangements. The method begins at step 400, in which a first end node presents a frozen image of the desktop to the receiving end nodes. In the method of FIG. 4, each of the end nodes runs an instance of the user interface program being run at the first end node.

At step 410, the first end node fades-out the desktop. At step 420, the arrangement of the elements located on the desktop is described to a second end node, perhaps using metadata or other high-level descriptors. At step 430 the first end node transfers control of the desktop to the second end node. At step 440 the second end node fades-in the frozen image of the desktop. At step 450, the second end node presents the desktop to the end nodes of the virtual collaboration session, wherein the first frame of the desktop presented is the frozen image.

In conclusion, while the present invention has been particularly shown and described with reference to various embodiments, those skilled in the art will understand that many variations may be made therein without departing from the spirit and scope of the invention as defined in the following claims. This description of the invention should be understood to include the novel and non-obvious combinations of elements described herein, and claims may be presented in this or a later patent application to any novel and non-obvious combination of these elements. The foregoing embodiments are illustrative, and no single feature or element is essential to all possible combinations that may be claimed in this or a later patent application. Where the claims recite “a” or “a first” element or the equivalent thereof, such claims should be understood to include incorporation of one or more such elements, neither requiring nor excluding two or more such elements.

What is claimed is:

1. A method of switching from a first host to a second host during a virtual collaboration session comprising:
a first end node receiving an indication that a user has requested a resource coupled to a second end node;
the first end node freezing a desktop transmitted to end nodes of the virtual collaboration session;
the second end node arranging elements of the desktop to coincide with elements of the frozen desktop; and
the second end node unfreezing the desktop and transmitting the desktop to the end nodes of the virtual collaboration session.

2. The method of claim 1, additionally comprising the first end node transmitting an indication that a host transfer is in progress.

3. The method of claim 1, further comprising the second end node transmitting the frozen desktop to the end nodes, the transmitting step being performed after the arranging step.

4. The method of claim 1, wherein the first end node fades-out the desktop transmitted, the fade-out being performed after the freezing step.

5. The method of claim 4, wherein the second end node fades-in the desktop, the fade-in being performed prior to the unfreezing step.

6. The method of claim 1, wherein the arranging step further comprises the first end node conveying high level commands to the second end node, the high level commands describing elements of the desktop and the location on the screen where the elements are to be placed.

7. A method of switching hosts during a virtual collaboration session comprising:
a first end node transmitting a frozen image of a desktop to a group of receiving end nodes of the virtual collaboration session;
the first end node transferring control of the desktop to a second end node; and
the second end node transmitting the desktop to a group of receiving end nodes of the virtual collaboration session, wherein
the desktop transmitted by the second end node is arranged substantially the same as the desktop transmitted by the first end node.

8. The method of claim 7, wherein the first end node fades-out the frozen image of the desktop.

9. The method of claim 7, wherein the second end node fades-in the frozen image of the desktop prior to the second end node transmitting the desktop to the group of receiving end nodes.

10. The method of claim 7, additionally comprising the first end node describing the frozen image of the desktop to the second end node prior to the second end node transmitting the desktop to the group of receiving end nodes.

11. The method of claim 10, wherein the frozen image is described by way of metadata.

12. The method of claim 7, wherein an audio signal from the first end node is blanked while the first end node transfers control of the desktop to the second end node.

13. The method of claim 12, further comprising fading-out the desktop while the first end node transfers control of the desktop to the second end node.

14. The method of claim 7, wherein the step of the first end node transmitting the frozen image of the desktop is in response to the second end node receiving a request for a resource coupled to the second end node.

15. A system for performing a host transfer from a first to a second end node during a virtual collaboration session, the first and second end nodes being selected from a plurality of end nodes of a virtual collaboration session, comprising:
means for transmitting, by the first end node, a desktop to the plurality of end nodes;
means for receiving a request for a resource associated with the second end node;
means for freezing a desktop transmitted by the first end node; and
means for describing the frozen image to the second end node.

16. The system of claim 15, further comprising means for transmitting an indicator from the first end node to the plurality of end nodes, the indicator indicating that the host transfer is in progress.

17. The system of claim 15, additionally comprising means for arranging elements of the desktop transmitted from the first end node to form a corresponding desktop transmitted from the second end node.

18. The system of claim 15, additionally comprising means for collecting state information about the desktop being transmitted by the first end node and conveying the state information to the second end node.

19. The system of claim 18, further comprising means for expressing the state information about the desktop being transmitted by the first end node using high level descriptors.

20. The system of claim 15, additionally comprising means for blanking the audio transmitted from the first end node during the host transfer.
